(19) United States
(12) Patent Application Publication
(10) Pub. No.: US 2026/0319508 A1
(43) Pub. Date: Oct. 15, 2026

(54) SELF-MOVING CLEANING DEVICE AND CONTROL METHOD THEREFOR

(71) Applicant: Beijing Roborock Technology Co., Ltd., Beijing (CN)

(72) Inventor: Liang DANG, Beijing (CN)

(21) Appl. No.: 19/689,973

(22) Filed: May 27, 2026

Related U.S. Application Data
(63) Continuation of application No. PCT/CN2025/074317, filed on Jan. 23, 2025.

(30) Foreign Application Priority Data
Dec. 1, 2023 (CN) 202311634649.4

(51) Int. Cl. G05D 1/622; A47L 9/00; A47L 9/28; A47L 11/40; G05D 1/648; G05D 105/10

(52) U.S. Cl. CPC G05D 1/622; A47L 9/009; A47L 9/2826; A47L 9/2852; A47L 11/4011; A47L 11/4061; G05D 1/6484; A47L 2201/04; G05D 2105/10

(57) ABSTRACT

A self-moving cleaning device and a control method therefor. The method comprises: acquiring the positions of all safe regions in a region to be cleaned; when a self-moving cleaning device travels to any safe region, acquiring the current detection parameter of an optical sensor of the self-moving cleaning device; adjusting the current detection parameter of the optical sensor to a target detection parameter, so as to reduce the detection precision of the optical sensor; on the basis of the target detection parameter, determining whether there is a cliff in the safe region, and if so, executing an avoidance policy, and if not, completing a task corresponding to the safe region; and when the self-moving cleaning device moves out of the safe region, adjusting a target calibration detection parameter to the current detection parameter, so as to recover the detection precision of the optical sensor.

### CROSS-REFERENCE TO RELATED APPLICATION

The present disclosure is a continuation application of International Application No. PCT/CN2025/074317, filed on Jan. 23, 2025, which claims priority to Chinese Patent Application No. 2023116346494 filed on Dec. 1, 2023, which are incorporated herein by reference in their entirety as a part of the present disclosure.

### TECHNICAL FIELD

The present disclosure relates to the field of smart home technologies, and in particular, to a self-propelled cleaning device and a control method therefor.

### BACKGROUND ART

With the development of intelligent cleaning technologies, self-propelled cleaning devices (such as sweeping robots) have entered more and more homes, which greatly reduces the burden of house cleaning for people. During the cleaning operation of the self-propelled cleaning device, regions with steps, stairs, or height differences may be encountered. Therefore, the self-propelled cleaning device needs to accurately detect cliffs during travel and adopt an avoidance strategy to prevent the self-propelled cleaning device from falling.

It should be noted that the information disclosed in the above background section is only used for the enhancement of understanding of the background of the present disclosure and, therefore, may include information that does not constitute the prior art known to those of ordinary skill in the art.

### SUMMARY OF THE INVENTION

A series of simplified concepts is introduced in the SUMMARY section, which will be further described in detail in the DETAILED DESCRIPTION section below. The SUMMARY section of the present disclosure is not intended to attempt to define key features and essential technical features of the claimed technical solutions, nor is it intended to attempt to delineate the protection scope of the claimed technical solutions.

In a first aspect, one embodiment of the present disclosure provides a control method for a self-propelled cleaning device. The control method includes:
acquiring positions of all safe regions in a region to be cleaned;
acquiring, when a self-propelled cleaning device travels to any one of the safe regions, a current detection parameter of an optical sensor of the self-propelled cleaning device;
adjusting the current detection parameter of the optical sensor to a target detection parameter so as to reduce detection precision of the optical sensor;
determining, based on the target detection parameter, whether a cliff exists in the safe region; if so, executing an avoidance strategy; and if not, completing a task corresponding to the safe region; and
adjusting, when the self-propelled cleaning device moves out of the safe region, the target calibration detection parameter to the current detection parameter so as to restore the detection precision of the optical sensor.

In a second aspect, one embodiment of the present disclosure provides a self-propelled cleaning device. The self-propelled cleaning device includes a main body, where an optical sensor and a controller are disposed on the main body, and the optical sensor includes a light emitting portion and a light receiving portion.

The light emitting portion is configured to emit an emergent light to a region to be cleaned. The light receiving portion is configured to receive at least part of reflected light, and the reflected light is formed by reflecting the emergent light of the light emitting portion by the surface of the region to be cleaned. The controller is configured to perform the control method for the self-propelled cleaning device described above.

In a third aspect, one embodiment of the present disclosure provides a self-propelled cleaning device. The self-propelled cleaning device includes a controller,
where the controller is configured to:
acquire positions of all safe regions in a region to be cleaned;
acquire, when a self-propelled cleaning device travels to any one of the safe regions, a current detection parameter of an optical sensor of the self-propelled cleaning device; and
adjust the current detection parameter of the optical sensor to a target detection parameter so as to reduce detection precision of the optical sensor.

In a fourth aspect, one embodiment of the present disclosure provides a non-transitory readable storage medium. The non-transitory readable storage medium stores a computer program code, and when the computer program code is executed by a computing device, the computing device performs the method according to any one of the first aspect to the third aspect described above.

In a fifth aspect, one embodiment of the present disclosure further provides a computer program product. The computer program product is stored in a storage medium, and when the computer program product is executed by at least one processor, the method according to any one of the first aspect to the third aspect described above is implemented.

### BRIEF DESCRIPTION OF THE DRAWINGS

The following drawings of the present disclosure are used herein as part of embodiments of the present disclosure for understanding the present disclosure. The embodiments of the present disclosure and descriptions thereof are shown in the drawings to explain the principles of the present disclosure.

In the drawings:

FIG. 1 is a perspective view of a sweeping robot according to one optional embodiment of the present disclosure;

FIG. 2 is a bottom view of FIG. 1;

FIG. 3 is a perspective view of a wet cleaning system according to one optional embodiment of the present disclosure;

FIG. 4 is a principle diagram illustrating detection of a region to be cleaned by an optical sensor according to one optional embodiment of the present disclosure;

FIG. 5 is a flowchart of a control method for a self-propelled cleaning device according to one optional embodiment of the present disclosure;

FIG. 6 is a flowchart of step S103 according to one optional embodiment of the present disclosure;

FIG. 7 is a flowchart of step S103 according to another optional embodiment of the present disclosure;

FIG. 8 is a flowchart of step S104 according to one optional embodiment of the present disclosure;

FIG. 9 is a flowchart of step S103 according to yet another optional embodiment of the present disclosure; and

FIG. 10 is a flowchart of step S104 according to one optional embodiment of the present disclosure.

### REFERENCE NUMERALS

10—sweeping robot, 110—main body, 111—forward portion, 112—rearward portion, 120—sensing assembly, 121—position determining sensor, 122—forward collision structure, 130—human-machine interaction assembly, 140—left wheel, 141—right wheel, 142—driven wheel, 150—cleaning system, 151—dry cleaning system, 152—side brush, 153—wet cleaning system, 1531—cleaning head, 1532—driving unit, 1533—driving platform, 1534—supporting platform, 20—optical sensor, 210—light emitting portion, 220—light receiving portion, 230—first convex lens, 240—second convex lens, 250—partition plate, 30—region to be cleaned.

### DETAILED DESCRIPTION

In the following description, numerous specific details are set forth to provide a more thorough understanding of the present disclosure. However, it will be apparent to those skilled in the art that the present disclosure can be implemented without one or at least three of these details. In other examples, to avoid confusion with the present disclosure, some technical features well known in the art are not described.

It should be noted that the terms used herein are only for the purpose of describing specific embodiments, and are not intended to limit exemplary embodiments according to the present disclosure. As used herein, the singular forms are intended to include the plural forms as well, unless the context clearly indicates otherwise. In addition, it should be further understood that the terms “comprise” and/or “include” as used in the specification indicate the presence of the stated features, integers, steps, operations, elements, and/or assemblies, but do not exclude the presence or addition of one or at least three other features, integers, steps, operations, elements, assemblies, and/or combinations thereof.

Exemplary embodiments according to the present disclosure will now be described in more detail with reference to the drawings. However, these exemplary embodiments may be implemented in various forms and should not be construed as being limited to the embodiments set forth herein. It should be understood that these embodiments are provided to make the disclosure of the present disclosure thorough and complete, and to fully convey the concepts of these exemplary embodiments to those of ordinary skill in the art.

At present, an optical sensor mounted on the self-propelled cleaning device is usually used to detect whether cliffs exist in a region to be cleaned. However, when the self-propelled cleaning device tilts due to crossing an obstacle (such as a door threshold) or encounters a light-absorbing region such as a dark blanket, the optical sensor may misjudge these regions as cliffs. As a result, the self-propelled cleaning device executes the avoidance strategy, such that the self-propelled cleaning device cannot complete the task of crossing the obstacle or cleaning the light-absorbing region such as the dark blanket, thereby adversely affecting the user's operation of the self-propelled cleaning device.

An optical sensor 20 according to one embodiment of the present disclosure may be applied to a self-propelled cleaning device. Specifically, the optical sensor 20 may be used as a cliff sensor. The self-propelled cleaning device is a device that automatically travels in a region to be cleaned 30 and automatically performs cleaning operations, such as a sweeping robot, a mopping robot, a sweeping and mopping integrated robot, a sprinkler robot, a floor polishing robot, or a weeding robot. For convenience of description, in this embodiment, the technical solutions of the present disclosure are described by using a sweeping robot 10 as an example.

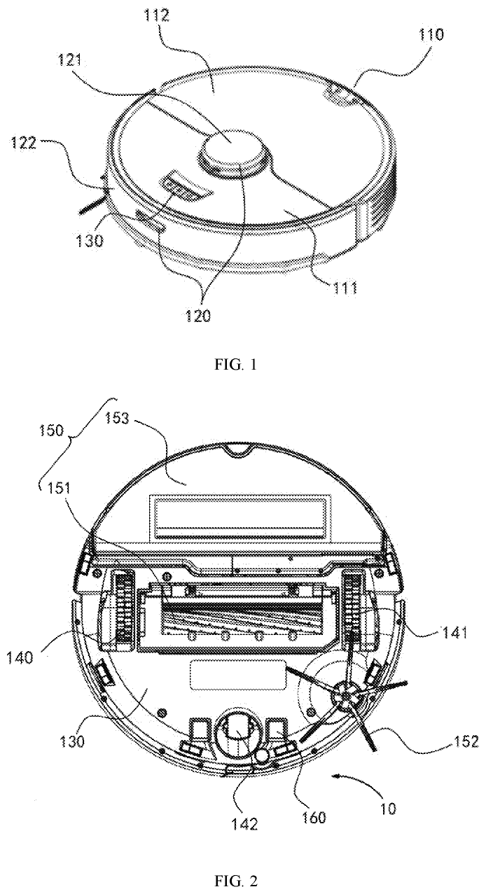

Further, as shown in FIGS. 1 and 2, the sweeping robot 10 includes a main body 110, a sensing assembly 120, a controller, a driving assembly, a cleaning system 150, a power system, and a human-machine interaction assembly 130. As shown in FIG. 1, the main body 110 includes a forward portion 111 and a rearward portion 112, and the main body may have an approximately circular shape where both the front and rear are circular, or may also have other shapes, including but not limited to an approximately D shape with a rectangular front and a circular rear, and a rectangular or square shape with a rectangular or square front and a rectangular or square rear.

As shown in FIG. 1, the sensing assembly 120 includes a position determining apparatus 121 located on the main body 110, a collision sensor disposed on a forward collision structure 122 of the forward portion 111 of the main body 110, a wall sensor located on a side of the machine, a cliff sensor disposed on the lower portion of the main body 110, and sensing apparatuses such as a magnetometer, an accelerometer, a gyroscope, and an odometer disposed inside the main body 110. The sensing assembly is configured to provide various position information and motion state information of the machine to the controller. The components in the sensing assembly 120 may operate independently, or may operate together to more accurately perform the target function. The position determining apparatus 121 includes, but is not limited to, a camera and a laser distance sensor (LDS, short for laser distance sensor). In some preferred implementations, the position determining apparatus 121 (such as a camera and a laser distance sensor) is located on the front side of the main body 110, that is, the foremost end of the forward portion 111, so as to more accurately sense the environment in front of the sweeping robot and achieve accurate positioning. The controller is further configured to perform the control method for the self-propelled cleaning device according to the present disclosure.

As shown in FIG. 1, the forward portion 111 of the main body 110 may carry the forward collision structure 122. During the cleaning process, a driving wheel assembly 141 propels the sweeping robot 10 to travel on the ground, the forward collision structure 122 detects, via a sensor system disposed on the forward collision structure, such as a collision sensor or a proximity sensor (infrared sensor), one or more events in a travel path of the sweeping robot 10. The sweeping robot 10 may control, based on the event detected by the forward collision structure 122, such as an obstacle or a wall, the driving assembly to cause the sweeping robot 10 to respond to the event, such as performing an obstacle avoidance operation to move away from the obstacle.

The controller is arranged on a main circuit board in the main body 110, and includes a computing processor, such as a central processing unit or an application processor, in communication with a non-transitory memory, such as a hard disk, a flash memory, or a random access memory. The application processor draws, based on obstacle information fed back by the laser distance sensor, a real-time map of the environment in which the sweeping robot 10 is located by using a positioning algorithm, such as simultaneous localization and mapping (SLAM, short for simultaneous localization and mapping). In addition, in combination with distance information and speed information that are fed back by sensing apparatuses, such as the sensor disposed on the forward collision structure 122, the cliff sensor 123, the magnetometer, the accelerometer, the gyroscope, and the odometer, the current operating state and position of the sweeping robot 10, as well as the current pose of the sweeping robot 10, such as crossing a door threshold, getting onto a carpet, being located at a cliff, being stuck from above or below, having a full dust box, or being picked up, are comprehensively determined. Moreover, specific next-action strategies are also provided for different situations, such that the sweeping robot 10 can achieve improved cleaning performance and user experience.

As shown in FIG. 2, the driving assembly may steer the main body 110 to travel across the ground based on driving commands with distance and angle information. The driving assembly includes a main driving wheel assembly, and the main driving wheel assembly may control a left wheel 140 and a right wheel 141. In order to more accurately control the movement of the machine, the main driving wheel assembly preferably includes a left driving wheel assembly and a right driving wheel assembly, respectively. The left driving wheel assembly and the right driving wheel assembly are disposed along a lateral axis defined by the main body 110. In order to enable the sweeping robot 10 to move more stably on the ground or have a stronger movement ability, the sweeping robot 10 may include one or more driven wheels 142, and the driven wheels 142 include, but are not limited to, universal wheels. The main driving wheel assembly includes a drive motor and a control circuit for controlling the drive motor. The main driving wheel assembly may be further connected to a circuit for measuring the drive current and an odometer. In addition, the left wheel 140 and the right wheel 141 may be provided with a biased drop suspension system that is movably secured, such as rotatably attached, to the main body 110, and receives a spring bias that is biased downward and away from the main body 110. The spring bias allows the driving wheel to maintain contact and traction with the ground with a certain ground grip, while a cleaning element of the sweeping robot 10 is also in contact with the ground with a certain pressure.

The power system includes a rechargeable battery, for example, a nickel-hydrogen battery and a lithium battery. The rechargeable battery may be connected to a charging control circuit, a battery pack charging temperature detection circuit, and a battery undervoltage monitoring circuit. The charging control circuit, the battery pack charging temperature detection circuit, and the battery undervoltage monitoring circuit are then connected to a single-chip microcomputer control circuit. The main unit is charged by connection to a charging dock via charging electrodes 160 arranged on the side or bottom of the machine body.

The human-machine interaction assembly 130 includes buttons on a main unit panel for the user to select a function, and may further include a display screen and/or an indicator light and/or a speaker, where the display screen, the indicator light, and the speaker show the current mode of the machine or function options to the user. The human-machine interaction assembly may further include a mobile phone client program. For a path-navigation-type sweeping robot 10, a mobile phone client can display to the user a map of the environment in which the device is located and the position of the machine, providing the user with richer and more user-friendly function options. Specifically, the sweeping robot 10 has a plurality of modes, such as an operating mode and a self-cleaning mode. The operating mode refers to the mode in which the sweeping robot 10 performs automatic cleaning operations, and the self-cleaning mode refers to the mode in which the sweeping robot 10 removes dirt from the roller brush and the side brush 152 on the base and automatically collects the dirt, and/or automatically cleans and dries the mopping cloth.

The cleaning system 150 may be a dry cleaning system 151 and/or a wet cleaning system 153.

As shown in FIG. 2, the dry cleaning system 151 according to one embodiment of the present disclosure may include a roller brush, a dust box, a fan, and an air outlet. The roller brush, with certain interference with the ground, sweeps up garbage on the ground and rolls up the garbage to the front of a dust suction inlet between the roller brush and the dust box, and then the garbage is sucked into the dust box by air having a suction force, which is generated by the fan and passes through the dust box. The dry cleaning system 151 may also include a side brush 152 with a rotation shaft that is angled relative to the ground to move debris into the roller brush region of the cleaning system 150.

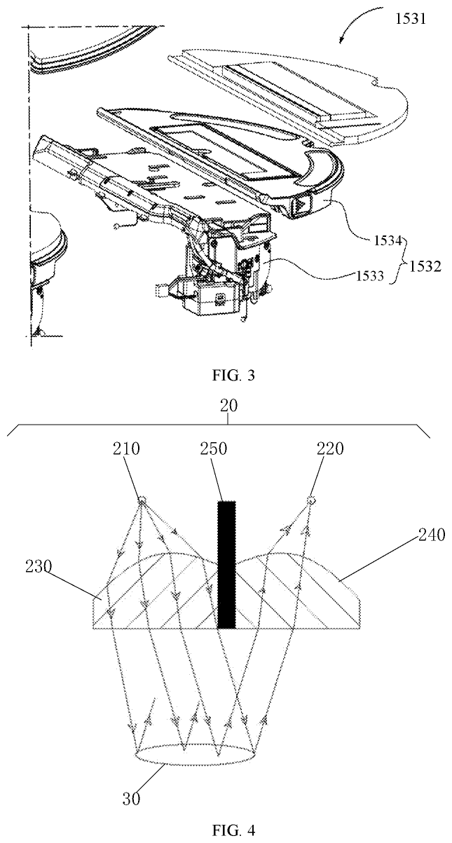

As shown in FIGS. 2 and 3, the wet cleaning system 153 according to one embodiment of the present disclosure may include: a cleaning head 1531, a driving unit 1532, a water supply mechanism, a liquid storage tank, and the like. The cleaning head 1531 may be disposed below the liquid storage tank, and the cleaning solution inside the liquid storage tank is delivered to the cleaning head 1531 through the water supply mechanism, such that the cleaning head 1531 performs wet cleaning on a plane to be cleaned. In other embodiments of the present disclosure, the cleaning solution inside the liquid storage tank may also be directly sprayed onto the plane to be cleaned, and the cleaning head 1531 cleans the plane by evenly applying the cleaning solution.

The cleaning head 1531 is configured to clean a surface to be cleaned. The driving unit 1532 is configured to drive the cleaning head 1531 to substantially reciprocate along a target surface. The target surface is a part of the surface to be cleaned. The cleaning head 1531 reciprocates along the surface to be cleaned, a mopping cloth is disposed on a surface of the cleaning head 1531 in contact with the surface to be cleaned, and the driving unit 1532 drives the mopping cloth of the cleaning head 1531 to reciprocate to generate a high-frequency friction with the surface to be cleaned, thereby removing stains on the surface to be cleaned; or the mopping cloth may be disposed in a floating manner and is always in contact with the surface to be cleaned during the cleaning process, without the need for the driving unit 1532 to drive the mopping cloth to reciprocate.

As shown in FIG. 3, the driving unit 1532 may further include a driving platform 1533 and a supporting platform 1534. The driving platform 1533 is connected to the bottom surface of the main body 110 for providing a driving force, and the supporting platform 1534 is detachably connected to the driving platform 1533 for supporting the cleaning head 1531 and can be lifted and lowered under the driving of the driving platform 1533.

The wet cleaning system 153 may be connected to the main body 110 through an active lifting/lowering assembly. When the wet cleaning system 153 is temporarily not involved in the operation, for example, the sweeping robot 10 (the self-propelled cleaning device) docks at the base station to clean the cleaning head 1531 of the wet cleaning system 153 and inject water into the liquid storage tank; or when the surface to be cleaned cannot be cleaned by the wet cleaning system 153, the wet cleaning system 153 is lifted by the active lifting/lowering assembly.

The optical sensor 20 on the self-propelled cleaning device will be described in detail below. The optical sensor 20 may be a cliff sensor arranged at the bottom of the main body 110 and at the front and rear of the driving wheel assembly 141, and the cliff sensor is configured to prevent the self-propelled cleaning device from falling, thereby preventing damage to the self-propelled cleaning device. The aforementioned “front” refers to a side that is the same as the traveling direction of the self-propelled cleaning device, and the aforementioned “rear” refers to a side that is opposite to the traveling direction of the self-propelled cleaning device.

The cliff sensor and an ultrasonic sensor identify the surface to be cleaned, so as to determine the physical properties of the surface to be cleaned, including the surface material, the degree of cleanliness, and the like, and can combine with the camera, the laser distance sensor, and the like for more accurate determination. For example, whether the surface to be cleaned is a carpet can be determined by the ultrasonic sensor. If the ultrasonic sensor determines that the surface to be cleaned is made of a carpet material, the controller controls the self-propelled cleaning device to perform cleaning in a carpet mode.

As shown in FIG. 4, the optical sensor 20 includes a light emitting portion 210 and a light receiving portion 220. The light emitting portion 210 is configured to emit an emergent light to the region to be cleaned 30. The light receiving portion 220 is configured to receive at least part of reflected light, and the reflected light is formed by reflecting the emergent light of the light emitting portion 210 by the surface of the region to be cleaned 30.

The region to be cleaned 30 is a region to be cleaned by the self-propelled cleaning device, and the region may be set by the user. In the present disclosure, the light emitting portion 210 emits the emergent light to the entire region to be cleaned 30; that is, the light emitting portion 210 emits the emergent light to a safe region in the region to be cleaned 30, and also emits the emergent light to other regions (i.e., non-safe regions) in the region to be cleaned.

Further, as shown in FIG. 4, a first convex lens 230 is disposed on an emission optical path of the light emitting portion 210, and the first convex lens 230 is configured to convert the emergent light emitted by the light emitting portion 210 into approximately parallel light. A second convex lens 240 is disposed on a receiving optical path of the light receiving portion 220, and the second convex lens 240 is configured to convert the light emitted to the light receiving portion 220 into converged light. Further, a partition plate 250 is disposed between the light emitting portion 210 and the light receiving portion 220, and the partition plate 250 is made of an opaque material, so as to prevent the emergent light emitted from the light emitting portion 210 from being directly received by the light receiving portion 220 without being reflected by the surface of the region to be cleaned 30 of the self-propelled cleaning device.

As shown in FIG. 4, when the optical sensor 20 is in operation, the light emitting portion 210 emits an emergent light, the emergent light is converted into approximately parallel light by the first convex lens 230, the parallel light is reflected by the surface of the region to be cleaned 30 of the self-propelled cleaning device to form approximately parallel reflected light, and then at least part of the reflected light is converted into converged light by the second convex lens 240 and received by the light receiving portion 220. The controller determines, based on the light intensity value of the reflected light received by the light receiving portion 220, whether a cliff exists in the region to be cleaned 30, that is, if the light intensity value of the reflected light received by the light receiving portion 220 is greater than or equal to the light intensity threshold, it is determined that no cliff exists in the region to be cleaned 30; and if the light intensity value of the reflected light received by the light receiving portion 220 is less than the light intensity threshold, it is determined that a cliff exists in the region to be cleaned 30.

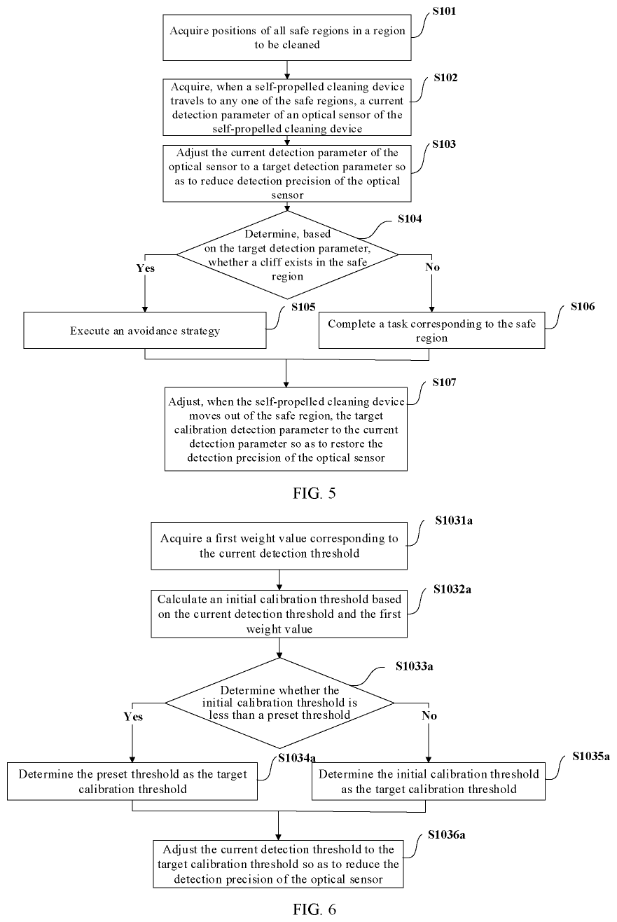

A control method for a self-propelled cleaning device according to one embodiment of the present disclosure will be described in detail below. Specifically, as shown in FIGS. 4 and 5, one embodiment of the present disclosure provides a control method for a self-propelled cleaning device. The control method includes:

In step S101, positions of all safe regions in a region to be cleaned 30 are acquired.

The safe region refers to a region that is prone to causing misjudgment by the optical sensor 20, such as obstacles higher than the surface of the region to be detected (e.g., a doorstone or a door threshold) or light-absorbing regions (e.g., a dark carpet). The safe region may be set by the user in the region to be cleaned 30. For example, regions where a doorstone, a door threshold, and a dark carpet are located may be set as safe regions. The number of the safe regions may be determined by the user based on the actual situation, which is not strictly limited in this embodiment.

In step S102, when the self-propelled cleaning device travels to any one of the safe regions, a current detection parameter of an optical sensor 20 of a self-propelled cleaning device is acquired.

In step S103, the current detection parameter of the optical sensor 20 is adjusted to a target detection parameter so as to reduce the detection precision of the optical sensor 20.

Reducing the detection precision of the optical sensor 20 in the safe region can prevent the optical sensor 20 from misjudging the safe region as a cliff, such that the self-propelled cleaning device smoothly performs the corresponding task (such as crossing an obstacle or cleaning a dark carpet) in the safe region, thereby facilitating the user's operation of the self-propelled cleaning device. In addition, the optical sensor 20 with reduced detection precision still has a certain level of detection capability. In this way, when the optical sensor 20 detects that a cliff exists in the safe region, the self-propelled cleaning device is controlled to execute an avoidance strategy, thereby reducing the probability that the self-propelled cleaning device falls due to the cliff in the safe region, and further improving the operation reliability of the self-propelled cleaning device in the safe region.

In step S104, it is determined whether a cliff exists in the safe region based on the target detection parameter; if so, step S105 is executed; and if not, step S106 is executed.

In step S105, the avoidance strategy is executed.

When the optical sensor 20 determines that a cliff exists in the safe region, the self-propelled cleaning device is controlled to execute the avoidance strategy, so as to prevent damage to the self-propelled cleaning device due to falling from the cliff.

The avoidance strategy may be a strategy of controlling the self-propelled cleaning device to move backward. Certainly, other avoidance strategies may also be adopted, which are not strictly limited in this embodiment.

In step S106, a task corresponding to the safe region is completed.

When the optical sensor 20 determines that no cliff exists in the safe region, the self-propelled cleaning device is controlled to complete the task corresponding to the safe region, for example, crossing an obstacle such as a doorstone or a door threshold, or cleaning a dark carpet.

In step S107, when the self-propelled cleaning device moves out of the safe region, a target calibration detection parameter is adjusted to the current detection parameter so as to restore the detection precision of the optical sensor.

When the self-propelled cleaning device moves out of the safe region, the target calibration detection parameter is adjusted to the current detection parameter so as to restore the detection precision of the optical sensor, thereby ensuring the detection accuracy of the optical sensor 20 in other regions.

In practical applications, for different current detection parameters, the corresponding ways to reduce the detection precision of the optical sensor 20 are also different.

In some embodiments, the current detection parameter includes a current detection threshold, and the current detection threshold is used for comparing with the light intensity value of the reflected light received by the light receiving portion 220, so as to determine whether a cliff exists in the region to be operated other than the safe region (i.e., the non-safe region). The current detection threshold may be set by the staff based on the actual situation, which is not strictly limited in the embodiments.

In the case where the current detection parameter includes the current detection threshold, in one implementation, as shown in FIG. 6, step S103 includes the following.

In step S1031a, a first weight value corresponding to the current detection threshold is acquired.

The first weight value corresponding to the current detection threshold may be set by the staff, which is not strictly limited in this embodiment. The first weight values corresponding to different current detection thresholds may be the same, thereby reducing the workload of the staff.

In step S1032a, an initial calibration threshold is calculated based on the current detection threshold and the first weight value.

Specifically, the initial calibration threshold may be obtained by multiplying the current detection threshold by the first weight value. Illustratively, assuming that the current detection threshold is 90 and the first weight value is 0.5, the initial calibration threshold is 90*0.5=45.

In step S1033a, it is determined whether the initial calibration threshold is less than a preset threshold; if so, step S1034a is executed; and if not, step S1035a is executed.

The preset threshold may be set by the staff, which is not strictly limited in this embodiment. The initial calibration threshold is compared with the preset threshold, and a target calibration threshold is determined based on the comparison result, such that the target calibration threshold is not excessively low, thereby avoiding the case where the target calibration threshold is excessively small, resulting in excessively low detection precision of the optical sensor 20 and failure to detect the cliff in the safe region, and further ensuring that the optical sensor 20 still has a certain level of detection precision.

In step S1034a, the preset threshold is determined as the target calibration threshold.

Illustratively, assuming that the preset threshold is 20, the initial calibration threshold is 18, and the initial calibration threshold is less than the preset threshold, the target calibration threshold is 20.

In step S1035a, the initial calibration threshold is determined as the target calibration threshold.

Illustratively, assuming that the preset threshold is 20, the initial calibration threshold is 50, and the initial calibration threshold is greater than the preset threshold, the target calibration threshold is 50.

In step S1036a, the current detection threshold is adjusted to the target calibration threshold so as to reduce the detection precision of the optical sensor 20.

The current detection threshold is adjusted to the target calibration threshold; that is, the current detection threshold is reduced, so as to achieve the purpose of reducing the detection precision of the optical sensor 20. In this way, when the self-propelled cleaning device performs a corresponding task in the safe region and thus the light intensity value of the reflected light received by the optical sensor 20, that is, the current received light intensity value, is reduced, the detection result obtained by using the optical sensor 20 still indicates that no cliff exists in the safe region, such that the self-propelled cleaning device does not execute the avoidance strategy, thereby ensuring the smooth performance of the corresponding task.

Illustratively, in the prior art, when the self-propelled cleaning device crosses the obstacle in the safe region, the main body of the self-propelled cleaning device may tilt, causing significant diffusion of the emergent light emitted by the light emitting portion 210 of the optical sensor 20 and significant reduction (for example, reduction from 120 to 55) in the light intensity value of the reflected light received by the light receiving portion 220 of the optical sensor 20. Assuming that the current detection threshold is 90, when the self-propelled cleaning device crosses the obstacle, the light intensity value of 55 of the reflected light received by the light receiving portion 220 is less than the current detection threshold of 90. In this way, the detection result of the optical sensor 20 indicates that a cliff exists, causing the self-propelled cleaning device to execute the avoidance strategy, thereby interrupting the task of crossing the obstacle and preventing the self-propelled cleaning device from smoothly crossing the obstacle.

However, in the present disclosure, the current detection threshold of 90 is adjusted to the target calibration threshold of 45. In this way, when the self-propelled cleaning device crosses the obstacle in the safe region, the light intensity value of the reflected light received by the light receiving portion 220 of the optical sensor 20 is reduced from 120 to 55, and the light intensity value of 55 of the reflected light received by the light receiving portion 220 is still greater than the target calibration threshold of 45, such that the detection result of the optical sensor 20 indicates that no cliff exists. Therefore, the self-propelled cleaning device does not execute the avoidance strategy; that is, the self-propelled cleaning device can still continue to cross the obstacle.

Another example is that, in the prior art, when the self-propelled cleaning device travels to a safe region with a dark carpet, due to the light absorption of the dark carpet, the light intensity value of the reflected light received by the light receiving portion 220 of the optical sensor 20 is greatly reduced, for example, from 120 to 60. Assuming that the current detection threshold is 90, the light intensity value of 60 of the reflected light received by the light receiving portion 220 is less than the current detection threshold of 90. In this way, the detection result of the optical sensor 20 indicates that a cliff exists, causing the self-propelled cleaning device to execute the avoidance strategy, thereby interrupting the task of cleaning the dark carpet and preventing the self-propelled cleaning device from smoothly cleaning the dark carpet.

However, in the present disclosure, the current detection threshold of 90 is adjusted to the target calibration threshold of 45. In this way, when the self-propelled cleaning device cleans the dark carpet, the light intensity value of the reflected light received by the light receiving portion 220 of the optical sensor 20 is reduced from 120 to 60, and the light intensity value of 60 of the reflected light received by the light receiving portion 220 is still greater than the target calibration threshold of 45, such that the detection result of the optical sensor 20 indicates that no cliff exists. Therefore, the self-propelled cleaning device does not execute the avoidance strategy; that is, the self-propelled cleaning device can still continue to clean the dark carpet.

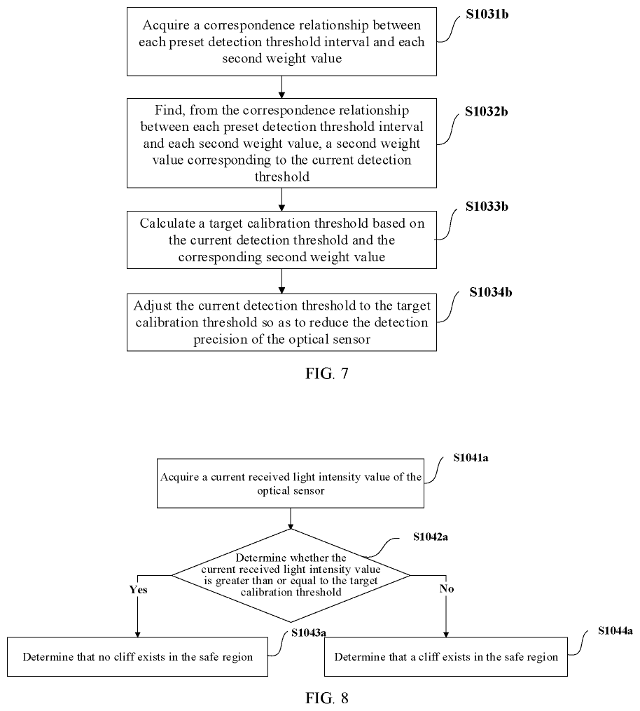

In another implementation, as shown in FIG. 7, step S103 includes the following.

In step S1031b, a correspondence relationship between each preset detection threshold interval and each second weight value is acquired.

Each detection threshold interval and the corresponding second weight value may be set by the staff, which is not strictly limited in this embodiment. The second weight values corresponding to the respective detection threshold interval may be partially identical or may all be different. In some embodiments, the second weight value increases as the value of the detection threshold interval decreases, so as to avoid the case where the subsequently obtained target calibration threshold is excessively small, resulting in excessively low detection precision of the optical sensor 20 and failure to detect the cliff in the safe region, thereby enabling the optical sensor 20 to still have a certain level of detection precision. For example, for a detection threshold interval of 80 to 100, the corresponding second weight value is 0.5; and for a detection threshold interval of 30 to 50, the corresponding second weight value is 0.7.

In step S1032b, the second weight value corresponding to the current detection threshold is found from the correspondence relationship between each preset detection threshold interval and each second weight value.

Illustratively, assuming that the current detection threshold is 35, if the second weight value corresponding to the detection threshold interval of 30 to 50 is 0.7, the second weight threshold corresponding to the current detection threshold of 35 is 0.7.

In step S1033b, a target calibration threshold is calculated based on the current detection threshold and the corresponding second weight value.

Specifically, the initial calibration threshold can be obtained by multiplying the current detection threshold by the second weight value. Illustratively, assuming that the current detection threshold is 35 and the first weight value is 0.7, the initial calibration threshold is 35*0.7=22.5.

In step S1034b, the current detection threshold is adjusted to the target calibration threshold so as to reduce the detection precision of the optical sensor 20.

In this embodiment, by setting different detection threshold intervals, the second weight value corresponding to the current detection threshold can be accurately matched, and then the target calibration threshold can be directly obtained, thereby improving the processing efficiency and also improving the accuracy of the target calibration threshold.

As shown in FIG. 8, in step S104, determining, based on the target detection parameter, whether a cliff exists in the safe region includes the following.

In step S1041a, the current received light intensity value of the optical sensor 20 is acquired.

The current received light intensity value of the optical sensor 20 is the current light intensity value of the reflected light received by the light receiving portion of the optical sensor 20.

In step S1042a, it is determined whether the current received light intensity value is greater than or equal to the target calibration threshold; if so, step S1043a is executed; and if not, step S1044a is executed.

In step S1043a, it is determined that no cliff exists in the safe region.

In step S1044a, it is determined that a cliff exists in the safe region.

Illustratively, assuming that the target calibration threshold is 45, if the current received light intensity value is 60, that is, the current received light intensity value is greater than the target calibration threshold, it indicates that no cliff exists in the safe region, and the self-propelled cleaning device can continue to complete its task in the safe region.

If the current received light intensity value is 30, that is, the current received light intensity value is less than the target calibration threshold, it indicates that a cliff exists in the safe region, and the self-propelled cleaning device executes the avoidance strategy to prevent damage caused by falling from the cliff.

In this embodiment, it is determined whether a cliff exists in the safe region based on the comparison result between the current received light intensity value and the target detection threshold. This can not only avoid misjudgment by the optical sensor 20 due to factors such as the self-propelled cleaning device crossing an obstacle or a dark carpet, but also ensure that the optical sensor 20 with reduced detection precision still has a certain level of detection capability. In this way, when the optical sensor 20 detects that a cliff exists in the safe region, the self-propelled cleaning device is controlled to execute the avoidance strategy, thereby reducing the probability that the self-propelled cleaning device falls due to the cliff in the safe region, and further improving the operation reliability of the self-propelled cleaning device in the safe region.

Further, in the above embodiment, step S107 includes the following.

When the self-propelled cleaning device moves out of the safe region, the target calibration threshold is adjusted to the current detection threshold so as to restore the detection precision of the optical sensor.

When the self-propelled cleaning device moves out of the safe region, the target calibration threshold is adjusted to the current detection threshold so as to restore the detection precision of the optical sensor. That is, when the self-propelled cleaning device moves out of the safe region, the light intensity value of the reflected light received by the optical sensor 20 is compared with the current detection threshold to determine whether a cliff exists, thereby ensuring the detection accuracy of the optical sensor 20 in other regions.

In some embodiments, the current detection parameter includes the current received light intensity value, i.e., the current light intensity value of the reflected light received by the light receiving portion 220.

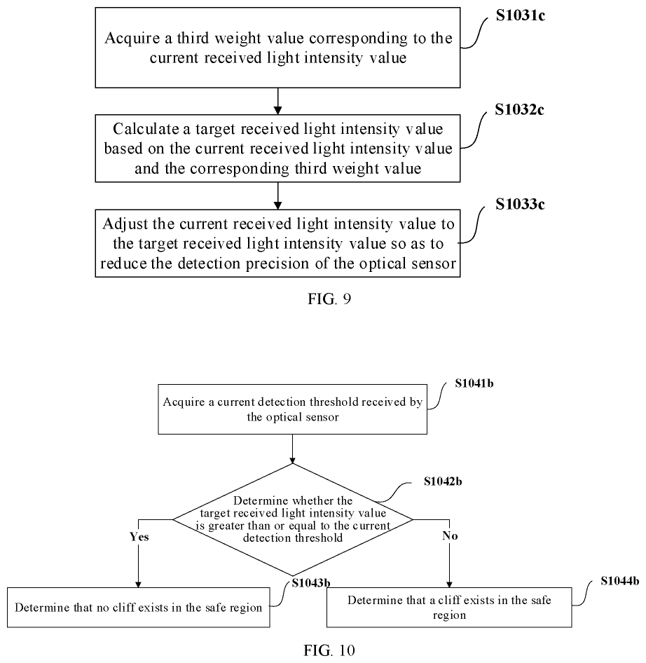

In the case where the current detection parameter includes the current received light intensity value, as shown in FIG. 9, step S103 includes the following.

In step S1031c, a third weight value corresponding to the current received light intensity value is acquired.

The third weight value may be set by the staff, which is not strictly limited in this embodiment.

In step S1032c, a target received light intensity value is calculated based on the current received light intensity value and the corresponding third weight value.

Specifically, the target received light intensity value can be obtained by multiplying the current received light intensity value by the third weight value. Illustratively, assuming that the current received light intensity value is 30 and the third weight value is 2, the target received light intensity value is 30*2=60.

In step S1033c, the current received light intensity value is adjusted to the target received light intensity value so as to reduce the detection precision of the optical sensor 20.

The current received light intensity value is adjusted to the target received light intensity; that is, the current detection threshold is reduced, so as to achieve the purpose of reducing the detection precision of the optical sensor 20. In this way, when the self-propelled cleaning device performs a corresponding task in the safe region and thus the light intensity value of the reflected light received by the optical sensor 20, that is, the current received light intensity value, is reduced, the detection result obtained by using the optical sensor 20 still indicates that no cliff exists in the safe region, such that the self-propelled cleaning device does not execute the avoidance strategy, thereby ensuring the smooth performance of the corresponding task.

Illustratively, in the prior art, when the self-propelled cleaning device crosses the obstacle in the safe region, the main body of the self-propelled cleaning device may tilt, causing significant diffusion of the emergent light emitted by the light emitting portion 210 of the optical sensor 20 and significant reduction (for example, reduction from 120 to 60) in the current light intensity value (i.e., the current received light intensity value) of the reflected light received by the light receiving portion 220 of the optical sensor 20. Assuming that the current detection threshold is 90, when the self-propelled cleaning device crosses the obstacle, the current received light intensity value of 60 is less than the current detection threshold of 90. In this way, the detection result of the optical sensor 20 indicates that a cliff exists, causing the self-propelled cleaning device to execute the avoidance strategy, thereby interrupting the task of crossing the obstacle and preventing the self-propelled cleaning device from smoothly crossing the obstacle.

However, in the present disclosure, the current received light intensity value is 60, and the target received light intensity value of 120 is calculated by the product of the current received light intensity value and the third weight value of 2. In this way, when the self-propelled cleaning device crosses the obstacle in the safe region, the target received light intensity value of 120 is compared with the current detection threshold of 90, and the target received light intensity value is greater than the current detection threshold, such that the detection result of the optical sensor 20 indicates that no cliff exists. Therefore, the self-propelled cleaning device does not execute the avoidance strategy; that is, the self-propelled cleaning device can still continue to cross the obstacle.

Another example is that, in the prior art, when the self-propelled cleaning device travels to a safe region with a dark carpet, due to the light absorption of the dark carpet, the light intensity value (i.e., the current received light intensity value) of the reflected light received by the light receiving portion 220 of the optical sensor 20 is greatly reduced, for example, from 100 to 50. Assuming that the current detection threshold is 90, the current received light intensity value of 50 is less than the current detection threshold of 90. In this way, the detection result of the optical sensor 20 indicates that a cliff exists, causing the self-propelled cleaning device to execute the avoidance strategy, thereby interrupting the task of cleaning the dark carpet and preventing the self-propelled cleaning device from smoothly cleaning the dark carpet.

However, in the present disclosure, the current received light intensity value is 50, and the target received light intensity value of 100 is calculated by the product of the current received light intensity value and the third weight value of 2. In this way, the target received light intensity value of 100 is compared with the current detection threshold of 90, and the target received light intensity value is greater than the current detection threshold, such that the detection result of the optical sensor 20 indicates that no cliff exists. Therefore, the self-propelled cleaning device does not execute the avoidance strategy; that is, the self-propelled cleaning device can still continue to clean the dark carpet.

As shown in FIG. 10, in step S104, determining, based on the target detection parameter, whether a cliff exists in the safe region includes the following.

In step S1041b, the current detection threshold received by the optical sensor 20 is acquired.

In step S1042b, it is determined whether the target received light intensity value is greater than or equal to the current detection threshold; if so, step S1043b is executed; and if not, step S1044b is executed.

In step S1043b, it is determined that no cliff exists in the safe region.

In step S1044b, it is determined that a cliff exists in the safe region.

Illustratively, assuming that the current calibration threshold is 90, if the target received light intensity value is 100, that is, the current received light intensity value is greater than the target calibration threshold, it indicates that no cliff exists in the safe region, and the self-propelled cleaning device can continue to complete its task in the safe region.

If the current received light intensity value is 70, that is, the current received light intensity value is less than the target calibration threshold, it indicates that a cliff exists in the safe region, and the self-propelled cleaning device executes the avoidance strategy to prevent damage caused by falling from the cliff.

In this embodiment, it is determined whether a cliff exists in the safe region based on the comparison result between the target received light intensity value and the current detection threshold. This can not only avoid misjudgment by the optical sensor 20 due to factors such as the self-propelled cleaning device crossing an obstacle or a dark carpet, but also ensure that the optical sensor 20 with reduced detection precision still has a certain level of detection capability. In this way, when the optical sensor 20 detects that a cliff exists in the safe region, the self-propelled cleaning device is controlled to execute the avoidance strategy, thereby reducing the probability that the self-propelled cleaning device falls due to the cliff in the safe region, and further improving the operation reliability of the self-propelled cleaning device in the safe region.

Further, in the above embodiment, step S107 includes the following.

When the self-propelled cleaning device moves out of the safe region, the target received light intensity value is adjusted to the current received light intensity value so as to restore the detection precision of the optical sensor.

When the self-propelled cleaning device moves out of the safe region, the target received light intensity value is adjusted to the current received light intensity value so as to restore the detection precision of the optical sensor. That is, when the self-propelled cleaning device moves out of the safe region, the current light intensity value of the reflected light received by the optical sensor 20 is compared with the current detection threshold to determine whether a cliff exists, thereby ensuring the detection accuracy of the optical sensor 20 in other regions.

Further, in the region to be cleaned 30, the range within a preset distance from the cliff is defined as a non-safe region, such that the optical sensor 20 cannot reduce the detection precision in this region, thereby avoiding the case where the optical sensor 20 fails to detect the cliff formed by, for example, a step due to reduced detection precision in the region of the cliff or in the vicinity of the cliff, such as the step.

The preset distance may be set by the staff, which is not strictly limited in this embodiment. In some embodiments, the preset distance is 1 m.

Further, in the above embodiment, after step S107, the method includes the following.

When the region to be cleaned 30 is updated, all the safe regions are eliminated.

In the case where the region to be cleaned 30 is updated, the original safe region is also eliminated; that is, the user needs to set a new safe region in the new region to be cleaned 30, such that the safe region changes with the change of the region to be cleaned 30.

One embodiment of the present disclosure further provides a self-propelled cleaning device. The self-propelled cleaning device includes a controller. The controller is configured to: acquire positions of all safe regions in a region to be cleaned; acquire, when a self-propelled cleaning device travels to any one of the safe regions, a current detection parameter of an optical sensor of the self-propelled cleaning device; and adjust the current detection parameter of the optical sensor to a target detection parameter so as to reduce detection precision of the optical sensor.

In one embodiment, the controller is further configured to: determine, based on the target detection parameter, whether a cliff exists in the safe region; if so, execute an avoidance strategy; and if not, complete a task corresponding to the safe region.

In one embodiment, the controller is further configured to: adjust, when the self-propelled cleaning device moves out of the safe region, the target calibration detection parameter to the current detection parameter so as to restore the detection precision of the optical sensor.

In one embodiment, the current detection parameter includes a current detection threshold.

In one embodiment, the controller is further configured to: acquire a first weight value corresponding to the current detection threshold; calculate an initial calibration threshold based on the current detection threshold and the first weight value; determine whether the initial calibration threshold is less than a preset threshold; if so, determine the preset threshold as a target calibration threshold; if not, determine the initial calibration threshold as the target calibration threshold; and adjust the current detection threshold to the target calibration threshold so as to reduce the detection precision of the optical sensor.

In one embodiment, the controller is further configured to: acquire a correspondence relationship between each preset detection threshold interval and each second weight value; find, from the correspondence relationship between each preset detection threshold interval and each second weight value, a second weight value corresponding to the current detection threshold; calculate a target calibration threshold based on the current detection threshold and the corresponding second weight value; and adjust the current detection threshold to the target calibration threshold so as to reduce the detection precision of the optical sensor.

In one embodiment, the controller is further configured to: acquire a current received light intensity value of the optical sensor; determine whether the current received light intensity value is greater than or equal to the target calibration threshold; if so, determine that no cliff exists in the safe region; and if not, determine that a cliff exists in the safe region.

In one embodiment, the controller is further configured to: adjust, when the self-propelled cleaning device moves out of the safe region, the target calibration threshold to the current detection threshold so as to restore the detection precision of the optical sensor.

In one embodiment, the current detection parameter includes a current received light intensity value.

In one embodiment, the controller is further configured to: acquire a third weight value corresponding to the current received light intensity value; calculate a target received light intensity value based on the current received light intensity value and the corresponding third weight value; and adjust the current received light intensity value to the target received light intensity value so as to reduce the detection precision of the optical sensor.

In one embodiment, the controller is further configured to: acquire a current detection threshold received by the optical sensor; determine whether the target received light intensity value is greater than or equal to the current detection threshold; if so, determine that no cliff exists in the safe region; and if not, determine that a cliff exists in the safe region.

In one embodiment, the controller is further configured to: adjust, when the self-propelled cleaning device moves out of the safe region, the target received light intensity value to the current received light intensity value so as to restore the detection precision of the optical sensor.

In one embodiment, in the region to be cleaned, the range within a preset distance from the cliff is defined as a non-safe region.

In one embodiment, the controller is further configured to: eliminate all the safe regions when the region to be cleaned is updated.

One embodiment of the present disclosure further provides a non-transitory readable storage medium. The non-transitory readable storage medium stores a computer program code, and when the computer program code is executed by a computing device, the computing device performs the control method for the self-propelled cleaning device according to any one of the above embodiments.

One embodiment of the present disclosure further provides a computer program product. The computer program product is stored in a storage medium, and when the computer program product is executed by at least one processor, the control method for the self-propelled cleaning device according to any one of the above embodiments is implemented.

In the self-propelled cleaning device and the control method therefor according to the embodiments of the present disclosure, when the self-propelled cleaning device travels to the safe region, the current detection parameter of the optical sensor of the self-propelled cleaning device is adjusted to the target detection parameter so as to reduce the detection precision of the optical sensor. In this way, in one aspect, the optical sensor can be prevented from misjudging the safe region as a cliff, such that the self-propelled cleaning device smoothly performs the corresponding task (such as crossing an obstacle or cleaning a dark carpet) in the safe region, thereby facilitating the user's operation of the self-propelled cleaning device. In another aspect, the optical sensor still has a certain level of detection capability. In this way, when the optical sensor detects that a cliff exists in the safe region, the self-propelled cleaning device is controlled to execute the avoidance strategy, thereby reducing the probability that the self-propelled cleaning device falls due to the cliff in the safe region, and further improving the operation reliability of the self-propelled cleaning device in the safe region. In addition, when the self-propelled cleaning device moves out of the safe region, the target calibration detection parameter is adjusted to the current detection parameter so as to restore the detection precision of the optical sensor, thereby ensuring the detection accuracy of the optical sensor in other regions.

Those skilled in the art can understand that all or some of the steps of the methods in the above embodiments may be completed by a computer program instructing related hardware. The program may be stored in a computer-readable storage medium, and when the program is executed, the steps of the above method embodiments may be executed. The storage medium may be implemented by any type of volatile or non-volatile storage device or a combination thereof, such as a random access memory (RAM), a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic disk (hard disk drive, HDD), a solid-state drive (solid-state drive, SSD), or an optical disc. The storage medium may further include a combination of the above types of memory.

It should be understood that although the steps in the flowcharts of the drawings are displayed sequentially by arrows, these steps are not necessarily executed in the order as indicated by the arrows. Unless explicitly stated herein, the execution of these steps is not strictly limited in order, and they may be executed in other orders. Moreover, at least some of the steps in the flowcharts of the drawings may include a plurality of sub-steps or a plurality of stages, which are not necessarily executed simultaneously, but may be executed at different times. Their execution order is not necessarily sequential, but may also be executed in turn or alternately with other steps or at least some of the sub-steps or stages in other steps.

The present disclosure has been described with reference to the above embodiments. It should be understood that, however, the above embodiments are only for the purpose of illustration and description and are not intended to limit the present disclosure to the scope of the embodiments described. In addition, those skilled in the art can understand that the present disclosure is not limited to the above embodiments. More variations and modifications can be made according to the teachings of the present disclosure, and these variations and modifications all fall within the protection scope of the present disclosure. The protection scope of the present disclosure is defined by the appended claims and their equivalents.

1. A control method for a self-propelled cleaning device, comprising:
acquiring positions of all safe regions in a region to be cleaned;
acquiring, when a self-propelled cleaning device travels to any one of the safe regions, a current detection parameter of an optical sensor of the self-propelled cleaning device; and
adjusting the current detection parameter of the optical sensor to a target detection parameter so as to reduce detection precision of the optical sensor.

2. The method according to claim 1, further comprising: determining, based on the target detection parameter, whether a cliff exists in the safe region; if so, executing an avoidance strategy; and if not, completing a task corresponding to the safe region.

3. The method according to claim 2, further comprising: adjusting, when the self-propelled cleaning device moves out of the safe region, the target calibration detection parameter to the current detection parameter so as to restore the detection precision of the optical sensor.

4. The method according to claim 3, wherein the current detection parameter comprises a current detection threshold.

5. The method according to claim 4, wherein adjusting the current detection parameter of the optical sensor to the target detection parameter so as to reduce the detection precision of the optical sensor comprises:
acquiring a first weight value corresponding to the current detection threshold;
calculating an initial calibration threshold based on the current detection threshold and the first weight value;
determining whether the initial calibration threshold is less than a preset threshold; if so, determining the preset threshold as a target calibration threshold; and if not, determining the initial calibration threshold as the target calibration threshold; and
adjusting the current detection threshold to the target calibration threshold so as to reduce the detection precision of the optical sensor,
or
wherein adjusting the current detection parameter of the optical sensor to the target detection parameter so as to reduce the detection precision of the optical sensor comprises:
acquiring a correspondence relationship between each preset detection threshold interval and each second weight value;
finding, from the correspondence relationship between each preset detection threshold interval and each second weight value, a second weight value corresponding to the current detection threshold;
calculating a target calibration threshold based on the current detection threshold and the corresponding second weight value; and
adjusting the current detection threshold to the target calibration threshold so as to reduce the detection precision of the optical sensor.

6. The method according to claim 5, wherein determining, based on the target detection parameter, whether a cliff exists in the safe region comprises:
acquiring a current received light intensity value of the optical sensor; and
determining whether the current received light intensity value is greater than or equal to the target calibration threshold; if so, determining that no cliff exists in the safe region; and if not, determining that a cliff exists in the safe region,
wherein adjusting, when the self-propelled cleaning device moves out of the safe region, the target calibration detection parameter to the current detection parameter so as to restore the detection precision of the optical sensor comprises:
adjusting, when the self-propelled cleaning device moves out of the safe region, the target calibration threshold to the current detection threshold so as to restore the detection precision of the optical sensor.

7. The method according to claim 3, wherein the current detection parameter comprises a current received light intensity value,
wherein adjusting the current detection parameter of the optical sensor to the target detection parameter so as to reduce the detection precision of the optical sensor comprises:
acquiring a third weight value corresponding to the current received light intensity value;
calculating a target received light intensity value based on the current received light intensity value and the corresponding third weight value; and
adjusting the current received light intensity value to the target received light intensity value so as to reduce the detection precision of the optical sensor.

8. The method according to claim 7, wherein determining, based on the target detection parameter, whether a cliff exists in the safe region comprises:
acquiring a current detection threshold received by the optical sensor; and
determining whether the target received light intensity value is greater than or equal to the current detection threshold; if so, determining that no cliff exists in the safe region; and if not, determining that a cliff exists in the safe region,
wherein adjusting, when the self-propelled cleaning device moves out of the safe region, the optical target calibration detection parameter to the current detection parameter so as to restore the detection precision of the optical sensor comprises:
adjusting, when the self-propelled cleaning device moves out of the safe region, the target received light intensity value to the current received light intensity value so as to restore the detection precision of the optical sensor.

9. The method according to claim 3, wherein in the region to be cleaned, a range within a preset distance from the cliff is defined as a non-safe region.

10. The method according to claim 3, wherein after adjusting, when the self-propelled cleaning device moves out of the safe region, the target detection parameter to the current detection parameter so as to restore the detection precision of the optical sensor, the method comprises:
eliminating all the safe regions when the region to be cleaned is updated.

11. A self-propelled cleaning device, comprising a controller,
wherein the controller is configured to:
acquire positions of all safe regions in a region to be cleaned;
acquire, when a self-propelled cleaning device travels to any one of the safe regions, a current detection parameter of an optical sensor of the self-propelled cleaning device; and
adjust the current detection parameter of the optical sensor to a target detection parameter so as to reduce detection precision of the optical sensor.

12. The device according to claim 11, the controller being further configured to: determine, based on the target detection parameter, whether a cliff exists in the safe region; if so, execute an avoidance strategy; and if not, complete a task corresponding to the safe region.

13. The device according to claim 12, the controller being further configured to: adjust, when the self-propelled cleaning device moves out of the safe region, the target calibration detection parameter to the current detection parameter so as to restore the detection precision of the optical sensor.

14. The device according to claim 13, wherein the current detection parameter comprises a current detection threshold.

15. The device according to claim 14, wherein the controller is further configured to:
acquire a first weight value corresponding to the current detection threshold;
calculate an initial calibration threshold based on the current detection threshold and the first weight value;
determine whether the initial calibration threshold is less than a preset threshold; if so, determine the preset threshold as a target calibration threshold; and if not, determine the initial calibration threshold as the target calibration threshold; and
adjust the current detection threshold to the target calibration threshold so as to reduce the detection precision of the optical sensor,
or
wherein the controller is further configured to:
acquire a correspondence relationship between each preset detection threshold interval and each second weight value;
find, from the correspondence relationship between each preset detection threshold interval and each second weight value, a second weight value corresponding to the current detection threshold;
calculate a target calibration threshold based on the current detection threshold and the corresponding second weight value; and
adjust the current detection threshold to the target calibration threshold so as to reduce the detection precision of the optical sensor.

16. The device according to claim 15, wherein the controller is further configured to:
acquire a current received light intensity value of the optical sensor; and
determine whether the current received light intensity value is greater than or equal to the target calibration threshold; if so, determine that no cliff exists in the safe region; and if not, determine that a cliff exists in the safe region,
wherein the controller is further configured to:
adjust, when the self-propelled cleaning device moves out of the safe region, the target calibration threshold to the current detection threshold so as to restore the detection precision of the optical sensor.

17. The device according to claim 13, wherein the current detection parameter comprises a current received light intensity value,
wherein the controller is further configured to:
acquire a third weight value corresponding to the current received light intensity value;
calculate a target received light intensity value based on the current received light intensity value and the corresponding third weight value; and
adjust the current received light intensity value to the target received light intensity value so as to reduce the detection precision of the optical sensor.

18. The device according to claim 17, wherein the controller is further configured to:
acquire a current detection threshold received by the optical sensor; and
determine whether the target received light intensity value is greater than or equal to the current detection threshold; if so, determine that no cliff exists in the safe region; and if not, determine that a cliff exists in the safe region,
wherein the controller is further configured to:
adjust, when the self-propelled cleaning device moves out of the safe region, the target received light intensity value to the current received light intensity value so as to restore the detection precision of the optical sensor.

19. The device according to claim 13, wherein in the region to be cleaned, a range within a preset distance from the cliff is defined as a non-safe region.

20. The device according to claim 13, wherein the controller is further configured to:
eliminate all the safe regions when the region to be cleaned is updated.
